(19) United States
(12) Patent Application Publication
(10) Pub. No.: US 2020/0292697 A1
(43) Pub. Date: Sep. 17, 2020

(54) RADAR DEVICE, WIRELESS ROTATING DEVICE OF RADAR, AND UNMANNED AERIAL VEHICLE

(71) Applicant: SZ DJI TECHNOLOGY CO., LTD., Shenzhen (CN)

(72) Inventors: Liangliang KUANG, Shenzhen (CN); Chunming WANG, Shenzhen (CN); Jiadi WANG, Shenzhen (CN); Xiang HE, Shenzhen (CN)

(21) Appl. No.: 16/890,627

(22) Filed: Jun. 2, 2020

Related U.S. Application Data
(63) Continuation of application No. PCT/CN2017/117004, filed on Dec. 18, 2017.

(51) Int. Cl. G01S 13/933; B64C 39/02; B64C 1/36; B64D 41/00

(52) U.S. Cl. CPC G01S 13/933; B64C 39/024; H04W 84/12; B64D 41/00; B64C 2201/027; B64C 1/36

(57) ABSTRACT

An unmanned aerial vehicle (UAV) includes a housing and a radar device. The radar device is mounted at the housing and includes a base, an antenna assembly, a power transmitter assembly, and a power receiver assembly. The antenna assembly is arranged at the base and configured to rotate relative to the base around a rotation axis. The power transmitter assembly is configured to convert first electric power into electromagnetic energy and transmit the electromagnetic energy. The power receiver assembly is disposed at a distance from the power transmitter assembly, is electrically connected to the antenna assembly, and is configured to rotate with the antenna assembly, convert the received electromagnetic energy into electric power and deliver the electric power to the antenna assembly.

### CROSS-REFERENCE TO RELATED APPLICATION

This application is a continuation of International Application No. PCT/CN2017/117004, filed Dec. 18, 2017, the entire content of which is incorporated herein by reference.

### TECHNICAL FIELD

The present disclosure relates to radar technology area and, more particularly, to a radar device, a radar wireless rotating device, and an unmanned aerial vehicle (UAV).

### BACKGROUND

With rapid development of unmanned aerial vehicle (UAV) technology and improvement of radar miniaturization technology, radar gradually becomes an important part of the UAV. An antenna assembly as a core component of the radar is driven by a drive mechanism when the radar is working, for example driven by an electric motor, to rotate around a rotation axis to detect obstacles of different directions. In conventional technologies, a cable is configured to connect the antenna assembly to an external power source to supply power to the antenna assembly. However, with this power supply method, due to limitation of the cable, a rotation angle of the drive mechanism is limited. For example, the rotation angle may only reach 270°. A rotation of 360° of the antenna assembly, such as an omnidirectional rotation, is not possible.

### SUMMARY

In accordance with the disclosure, there is provided an unmanned aerial vehicle (UAV) including a housing and a radar device. The radar device is mounted at the housing and includes a base, an antenna assembly, a power transmitter assembly, and a power receiver assembly. The antenna assembly is arranged at the base and configured to rotate relative to the base around a rotation axis. The power transmitter assembly is configured to convert electric power into electromagnetic energy and transmit the electromagnetic energy. The power receiver assembly is disposed at a distance from the power transmitter assembly, is electrically connected to the antenna assembly, and is configured to rotate with the antenna assembly, convert the electromagnetic energy into electric power, and transmit the electric power to the antenna assembly.

### BRIEF DESCRIPTION OF THE DRAWINGS

FIG. 1 is a schematic structural diagram of a radar device provided by embodiments of the present disclosure.

FIG. 2 is a sectional view of the radar device shown in FIG. 1.

FIG. 3 is a schematic structural diagram of a power transmitter assembly and a power receiver assembly of the radar device shown in FIG. 1.

FIG. 4 is a schematic structural diagram of a first wireless communication assembly and a second wireless communication assembly of the radar device shown in FIG. 1.

FIG. 5 is an unmanned aerial vehicle (UAV) including the radar device shown in FIG. 1.

### DETAILED DESCRIPTION OF THE EMBODIMENTS

Hereinafter, technical solutions of the embodiments of the present disclosure are described clearly in connection with the drawings. The described embodiments are merely some of the embodiments of the present disclosure, but not all the embodiments. Based on the described embodiments of the disclosure, all other embodiments obtained by one of ordinary skill in the art without any creative effort are within the scope of the present disclosure.

In accordance with the present disclosure, a radar device, a wireless rotating device, and an unmanned aerial vehicle (UAV) are described in detail in connection with the drawings as follows. Features of below described embodiments and implementations may be combined as long as there is no conflict, and technical solutions created by combining the features of the embodiments and implementations are also embodiments of the present disclosure.

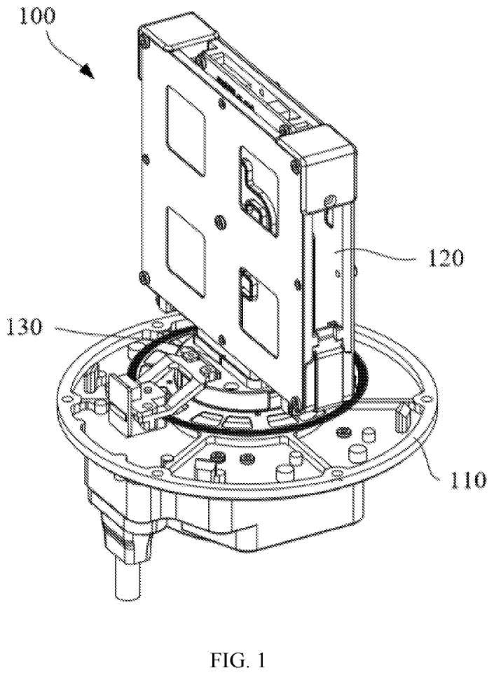

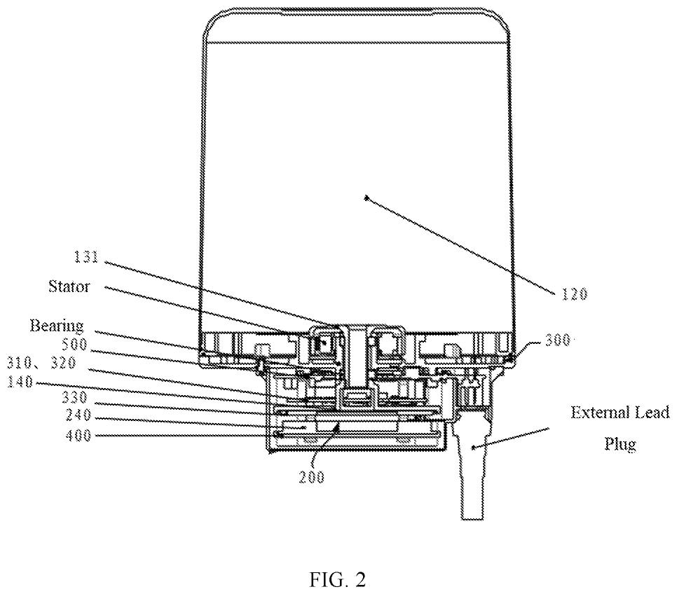

FIG. 1 and FIG. 2 are a schematic structural diagram and a sectional view of a radar device 100 provided by the embodiments of the present disclosure. As shown in FIG. 1 and FIG. 2, the radar device 100 includes a base 110, an antenna assembly 120, an antenna bracket 140 configured to support the antenna assembly 120, an electric motor 130, a power transmitter assembly 200, and a power receiver assembly 300.

As shown in FIG. 1, the antenna assembly 120 is arranged at the base 110 and can rotate around a rotation axis relative to the base 110. The rotation axis may be a physical axis or a virtual axis. When the rotation axis is a physical axis, the antenna assembly 120 may rotate relative to the rotation axis or may rotate together with the rotation axis. The electric motor 130 is arranged at the base 110 and includes a rotor 131 connected to the antenna assembly 120. The electric motor 130 is configured to drive the antenna bracket 140 to rotate, such that the antenna assembly 120 rotates with the antenna bracket 140 around the above-described rotation axis. The power transmitter assembly 300 and the power receiver assembly 400 are arranged with an interval therebetween. The power receiver assembly is electrically connected to the antenna assembly 120 and can rotate together with the antenna assembly 120. The power receiver assembly may cooperate with the power transmitter assembly to supply power to the antenna assembly 120, such that the antenna assembly 120 can work in normal.

In connection with the drawings, structures of the power receiver assembly and the power transmitter assembly, the cooperation of the power receiver assembly and the power transmitter assembly, and specific implementation principles and implementation processes of supplying power to the antenna assembly 120 are described in detail.

In the above-described radar device 100 shown in FIG. 1 and FIG. 2, the power transmitter assembly 200 is fixed and arranged at the base 110 shown in FIG. 1. The power receiver assembly is fixedly mounted at the antenna bracket 140 and rotates together with the antenna assembly.

The structures, working principles, and working processes of the power transmitter assembly and the power receiver assembly are described in detail.

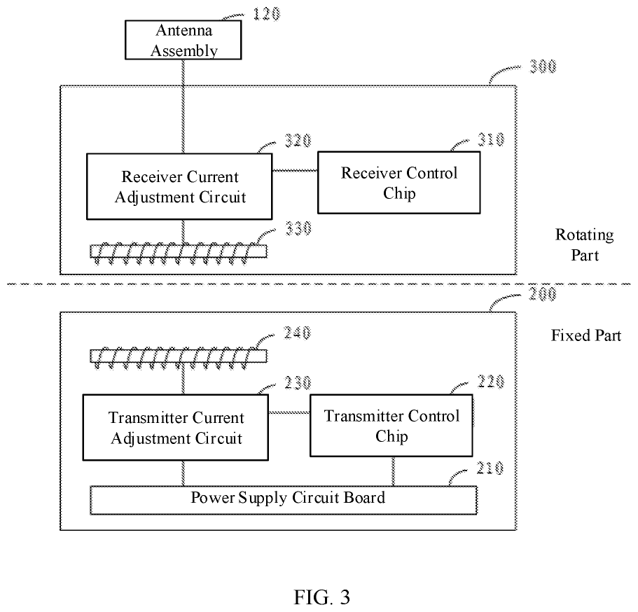

FIG. 3 is a schematic structural diagram of the power transmitter assembly 200 and the power receiver assembly 300 of the radar device shown in FIG. 1.

As shown in FIG. 3, the power transmitter assembly 200 includes a power supply circuit board 210, a transmitter control chip 220, a transmitter current adjustment circuit 230, and a transmitter coil 240.

The power supply circuit board 210 is electrically connected to the transmitter control chip 220 and the transmitter current adjustment circuit 230 and can supply power to the transmitter control chip 220 and the transmitter current adjustment circuit 230. In the embodiments, current supplied by the power supply circuit board 210 is direct current (DC). An intensity of the DC may be constant or dynamically changed, which is not limited by the present disclosure. The transmitter control chip 220 is electrically connected to the transmitter current adjustment circuit 230 and may be configured to control the transmitter current adjustment circuit 230 to convert the received DC power into alternating current (AC) power with a preset frequency range.

The transmitter current adjustment circuit 230 is electrically connected to the transmitter coil 240 and can transmit the converted AC power to the transmitter coil 240. The transmitter coil 240 can convert the received AC power into electromagnetic energy and transmit the electromagnetic energy.

In one embodiment, to convert the DC power into the AC power with the preset frequency range, the above-described transmitter current adjustment circuit 230 may include a transmitter current conversion circuit and a resonance circuit. The transmitter current conversion circuit is electrically connected to the resonance circuit. The transmitter current conversion circuit may use an “inverter” principle to convert the DC power provided by the power supply circuit board 210 into the AC power and transmit the converted AC power to the resonance circuit. Further, the resonance circuit can adjust a frequency of the received AC power to the preset frequency range.

As shown in FIG. 3, the power receiver assembly 300 includes a receiver control chip 310, a receiver current adjustment circuit 320, and a receiver coil 330. As shown in FIG. 3, the receiver coil 330 is disposed at a distance from the transmitter coil 240, and electrical power can be transmitted between the receiver coil 330 and the transmitter coil 240. The receiver coil 330 is electrically connected to the receiver current adjustment circuit 320. Since the receiver coil 330 is disposed at a distance from the transmitter coil 240, the electromagnetic energy transmitted by the transmitter coil 240 can be sensed. Based on the principle of electromagnetic induction, the received electromagnetic energy is converted into the AC power, and the AC power is transmitted to the receiver current adjustment circuit 320. Further, the receiver current adjustment circuit 320 is electrically connected to the receiver control chip 310. The receiver current adjustment circuit 320 can be controlled by the receiver control chip 310 to perform processing of rectification, filtering, etc., to the received AC power to convert the received AC power into the DC power. The receiver current adjustment circuit 320 is electrically connected to the antenna assembly 120 and can transmit the DC power to the antenna assembly 120 to supply power to the antenna assembly 120 to ensure that the antenna 120 works normally.

In some embodiments, the electric power transmission efficiency is related to the distance between the transmitter coil 240 and the receiver coil 330. If the distance between the transmitter coil 240 and the receiver coil 330 is too small, a mutual inductance phenomenon occurs between the transmitter coil 240 and the receiver coil 330, which affects the transmission efficiency. If the distance between the transmitter coil 240 and the receiver coil 330 is too large, the transmission distance is long, which affects the transmission efficiency. Therefore, the distance between the transmitter coil 240 and the receiver coil 330 may need to be within an appropriate range. In some embodiments, the distance between the transmitter coil 240 and the receiver coil 330 is controlled to be in the distance range of 1.5 mm˜5 mm. For example, the distance between the transmitter coil 240 and the receiver coil 330 may be 1.5 mm, 1.6 mm, 1.7 mm, 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm, 3.0 mm, 3.1 mm, 3.2 mm, 3.3 mm, 3.4 mm, 3.5 mm, 3.6 mm, 3.7 mm, 3.8 mm, 3.9 mm, 4.0 mm, 4.1 mm, 4.2 mm, 4.3 mm, 4.4 mm, 4.5 mm, 4.6 mm, 4.7 mm, 4.8 mm, 4.9 mm, and 5.0 mm.

Further, based on the distance range between the transmitter coil 240 and the receiver coil 330, and in order to ensure the subsequent DC power provided by the power receiver assembly 300 to the antenna assembly 120 can satisfy the current intensity needed by the antenna assembly 120 during normal operation, embodiments of the present disclosure also provide a configuration described below.

In some embodiments, the electric power transmission efficiency is related to an inductance value of the transmitter coil 240. If the inductance value of the transmitter coil 240 is too large or too small, a coupling degree between the transmitter coil 240 and a capacitor is reduced, which affects the transmission efficiency. Therefore, the inductance value of the transmitter coil 240 may need to be within an appropriate range. In some embodiments, the inductance value of the above-described transmitter coil 240 may be controlled to be in the inductance value range of 8.5 uH˜11 uH. For example, the inductance value of the above-described transmitter coil 240 may be 8.5 uH, 8.6 uH, 8.7 uH, 8.8 uH, 8.9 uH, 9.0 uH, 9.1 uH, 9.2 uH, 9.3 uH, 9.4 uH, 9.5 uH, 9.6 uH, 9.7 uH, 9.8 uH, 9.9 uH, 10.0 uH, 10.1 uH, 10.2 uH, 10.3 uH, 10.4 uH, 10.5 uH, 10.6 uH, 10.7 uH, 10.8 uH, 10.9 uH, and 11.0 uH.

In some embodiments, the electric power transmission efficiency is related to an inductance value of the receiver coil 330. If the inductance value of the receiver coil 330 is too large or too small, a coupling degree between the receiver coil 330 and a capacitor is reduced, which affects the transmission efficiency. Therefore, the inductance value of the receiver coil 330 may need to be within an appropriate range. In some embodiments, the inductance value of the above-described receiver coil 330 may be controlled to be in the inductance value range of 7.5 uH˜11 uH. For example, the inductance value of the above-described receiver coil 330 may be 7.5 uH, 7.6 uH, 7.7 uH, 7.8 uH, 7.9 uH, 8.0 uH, 8.1 uH, 8.2 uH, 8.3 uH, 8.4 uH, 8.5 uH, 8.6 uH, 8.7 uH, 8.8 uH, 8.9 uH, 9.0 uH, 9.1 uH, 9.2 uH, 9.3 uH, 9.4 uH, 9.5 uH, 9.6 uH, 9.7 uH, 9.8 uH, 9.9 uH, 10.0 uH, 10.1 uH, 10.2 uH, 10.3 uH, 10.4 uH, 10.5 uH, 10.6 uH, 10.7 uH, 10.8 uH, 10.9 uH, and 11.0 uH.

In some embodiments, the electric power transmission efficiency is related to a frequency of the AC power. If the frequency of the AC power is too large or too small, power consumption of the power transmitter assembly 200 and/or the power receiver assembly 300 increases, which affects the transmission efficiency. Therefore, the frequency of the AC power may need to be within an appropriate range. In some embodiments, a preset frequency range may be 120 KHz˜150 KHz. For example, the above-described preset frequency may be 120 KHz, 121 KHz, 122 KHz, 123 KHz, 124 KHz, 125 KHz, 126 KHz, 127 KHz, 128 KHz, 129 KHz, 130 KHz, 131 KHz, 132 KHz, 133 KHz, 134 KHz, 135 KHz, 136 KHz, 137 KHz, 138 KHz, 139 KHz, 140 KHz, 141 KHz, 142 KHz, 143 KHz, 144 KHz, 145 KHz, 146 KHz, 147 KHz, 148 KHz, 149 KHz, and 150 KHz.

In the radar device shown in FIG. 1, the power transmitter assembly is fixedly mounted at the base, the power receiver assembly is electrically connected to the antenna assembly, and the power receiver assembly is configured to rotate together with the antenna assembly. Further, the power transmitter assembly converts the received DC power into electromagnetic energy based on the principle of electromagnetic inductance, and transmits the electromagnetic energy, and the power receiver assembly converts the received electromagnetic energy into the DC power and transmits the DC power to the antenna assembly electrically connected to the power receiver assembly. That is, wireless power supply to the antenna assembly is realized. With this power supply method, since a cable is not needed to connect the antenna assembly to the external power source, the limitation of the cable is eliminated, such that the electric motor realize 360° omnidirectional rotation to drive the antenna to realize 360° omnidirectional rotation to better detect obstacles at different directions.

In some embodiments, the antenna assembly 120 also needs to transmit the detected information to a ground station and receive request instructions sent from the ground station. Thus, embodiments of the present disclosure also provide wireless communication.

In some embodiments, the radar device shown in FIG. 1 further includes a first wireless communication assembly 500 and a second wireless communication assembly 400 (not shown in FIG. 1). There is a wireless communication connection between the first wireless communication assembly 500 and the second wireless communication assembly 400. Based on a similar principle of the wireless power supply, the first communication assembly 500 is mounted at the antenna bracket 140 and is electrically connected to the antenna assembly 120, and the second communication assembly 400 is fixedly mounted at the base 110.

Based on an above-described structure, the first wireless communication assembly 500 can be configured to transmit the information detected by the antenna assembly 120 to the second wireless communication assembly 400 and receive the request instructions sent by the second wireless communication assembly 400.

In connection with the drawings, the structures of each of the first wireless communication assembly 500 and the second wireless communication assembly 400, and the implementation principle and implementation process of the wireless communication therebetween are described in detail as follows.

In the embodiments of the present disclosure, considering the volume and the structure of the miniature radar, an integrated chip solution may be used to integrate the power transmitter assembly 200 and the second wireless communication assembly 400 shown in FIG. 3 to a same electric circuit board. Correspondingly, the integrated chip solution may also be used to integrate the power receiver assembly 300 and the first wireless communication assembly shown in FIG. 3 to a same electric circuit board.

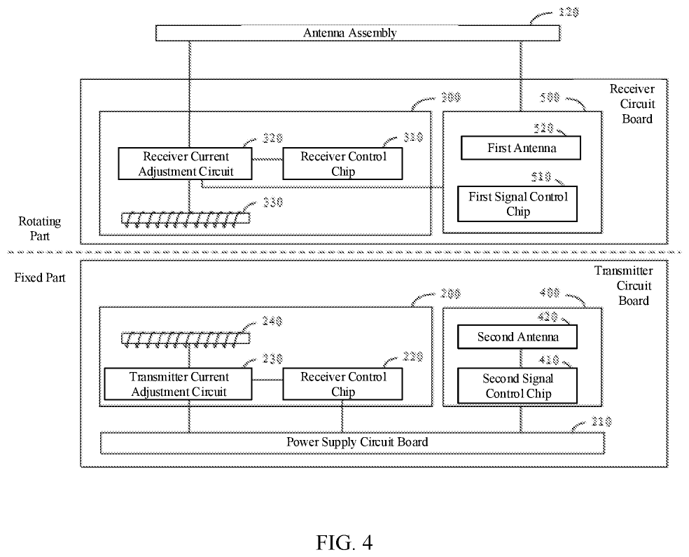

FIG. 4 shows the first wireless communication assembly 500 and the second wireless communication assembly 400. As shown in FIG. 4, the first wireless communication assembly 500 and the power receiver assembly 300 are integrated at the receiver circuit board, which is electrically connected to the receiver current adjustment circuit 320 of the power receiver assembly 300, such that the receiver current adjustment circuit 320 supplies power to the first wireless communication assembly 500. The first wireless communication assembly includes a first signal control chip 510 and a first antenna 520. The first signal control chip 510 may control the first antenna 520 to transmit digital signals detected by the antenna assembly 120 electrically connected to the first antenna 520, and receive digital signals sent from an external signal source, for example, the request instructions sent from the ground station.

As shown in FIG. 4, the second wireless communication assembly 400 and the power transmitter assembly 200 are integrated at a transmitter circuit board, which can be electrically connected to the power supply circuit board 210 of the power transmitter assembly 200 to supply power to the transmitter circuit board through the power supply circuit board 210. The second wireless communication assembly 400 includes a second signal control chip 410 and a second antenna 420. The second signal control chip 410 controls the second antenna 420 to receive digital signals sent from an external signal source, for example, to receive the digital signals sent from the first antenna 520, and transmit digital signals, for example, to transmit the request instructions sent from the ground station.

To implement wireless communication between the first antenna 520 and the second antenna 420, in one embodiment, the first antenna 520 may be a WIFI wireless antenna, and correspondingly, the second antenna 420 may also be a WIFI wireless antenna.

In another embodiment, the first antenna 520 may be a Bluetooth wireless antenna, and correspondingly, the second antenna 420 may also be a Bluetooth wireless antenna.

From a frequency band perspective, in one embodiment, the first antenna 520 may be a 2.4G wireless antenna, and correspondingly, the second antenna 420 may also be a 2.4G wireless antenna.

In another embodiment, the first antenna 520 may be a 5G wireless antenna, and correspondingly, the second antenna 420 may also be a 5G wireless antenna.

From a structure and shape perspective, in one embodiment, the first antenna 520 may be a plate antenna, and correspondingly, the second antenna 420 may also be a plate antenna.

With the above description, in the radar device shown in FIG. 1, the second wireless communication assembly 400 is fixedly mounted at the base, the first wireless communication assembly 500 is electrically connected to the antenna assembly, and there is a wireless communication connection therebetween. With such a communication method, since no cable is needed between the antenna assembly and the base to transmit the data signals, the limitation of the cable is eliminated, such that the electric motor can realize 360° omnidirectional rotation to drive the antenna assembly to realize 360° omnidirectional rotation to better detect the obstacles at different directions.

The present disclosure also provides a radar wireless rotating device, which can include a base, an antenna assembly, a power transmitter assembly, and a power receiver assembly. The antenna assembly can be arranged at the base and rotate around a rotation axis relative to the base. The power transmitter assembly can be configured to convert electric power into electromagnetic energy and transmit the electromagnetic energy. The power receiver assembly is electrically connected to the antenna assembly and rotates with the antenna assembly. The power receiver assembly can be configured to convert received electromagnetic energy into electric power and transmit the converted electric power to the antenna assembly. A structure, working principles, working processes, and realized working effects of the radar wireless rotating device are similar to those of the radar device described above, which are not repeated here.

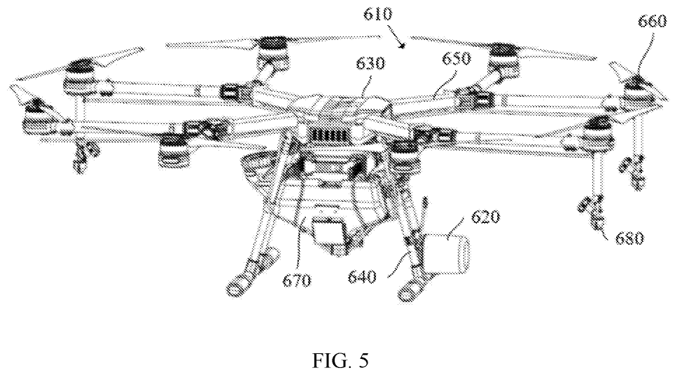

FIG. 5 shows a UAV consistent with embodiments of the disclosure. The UAV includes a housing 610 and a radar device 620. The radar device 620 is arranged at the housing 610, and an antenna assembly (not shown in FIG. 5) can establish a communication connection to a control system (not shown in FIG. 5) of the UAV to transmit obstacle information detected by the antenna assembly to the control system. The control system controls flight of the UAV to avoid an obstacle in flight according to the received obstacle information.

For a structure, working principles, working processes, and working effects of the radar device 620, reference may be made to relevant description above, which are not repeated here.

As shown in FIG. 5, the housing 610 includes a body 630 and stands 640 connected to two sides of the bottom of the body 630. Further, the housing 610 includes arms 650 connected to sides of the body 630.

In one embodiment, as shown in FIG. 5, the radar device 620 is fixedly connected to a stand 640.

Those skilled in the art should understand that fixedly connecting the above-described radar device 620 to the stand 640 is merely an example. In practical applications, the radar device 620 may be fixedly connected to another part, such as an arm 650, or a water tank.

Further, the UAV shown in FIG. 5 may be a multi-rotor UAV, such as a quadrotor UAV or an octo-rotor UAV. A propeller 660 is connected to an end of the arm 650 distal from the body 630. The propellers 660 provide flight power to the UAV.

In an embodiment, the UAV shown in FIG. 5 may be an agricultural UAV, and the bottom of the UAV is provided with a container 670 configured to contain pesticides or seeds. A spreading mechanism (not shown in FIG. 5) is provided at the container 670. The spreading mechanism spreads the seeds contained in the container 670 to realize automatic agricultural operations. A spraying mechanism 680 is further provided at the end of the arm 650 distal from the body 630 and sprays the pesticide contained in the container 670 to realize automatic agricultural operations.

For device embodiments, since the device embodiments basically correspond to method embodiments, reference may be made to corresponding description of the method embodiments. The above-described device embodiments are merely illustrative, where a unit described as a separate component may or may not be physically separated, and a component displayed as a unit may or may not be a physical unit, i.e., may be located at one place or be distributed to a plurality of network units. Some or all of the modules may be selected according to actual needs to achieve purpose of solutions of the embodiments. Those of ordinary skill in the art can understand and implement the solutions of the embodiments without any creative effort.

In the present disclosure, relational terms such as first and second are used merely to distinguish one entity or operation from another entity or operation and do not necessarily require or imply that such relationship or order exists between the entities or operations. The terms “including,” “comprising,” or any other variations cover a non-exclusive inclusion, such that a process, method, article, or device that includes a plurality of elements includes not only those elements but also other elements not listed, or elements that are inherent to such process, method, article, or device. In a situation without more limitations, an element associated with a phrase “include one . . . ” does not exclude presence of additional equivalent elements in the process, method, article, or device that includes the element.

The method and device provided by the embodiments of the present disclosure are described in detail above. The principles and implementations of the present disclosure are described with the specific examples. The description of the above embodiments is merely used to help to understand the methods and main ideas of the present disclosure. At the same time, for those of ordinary skill in the art, according to the ideas of the present disclosure, modifications may be made to specific embodiments and scope of applications. The present specification should not be construed as a limitation for the present disclosure.

What is claimed is:

1. An unmanned aerial vehicle (UAV) comprising:
a housing; and
a radar device mounted at the housing and including:
a base;
an antenna assembly arranged at the base and configured to rotate relative to the base around a rotation axis;
a power transmitter assembly configured to convert first electric power into electromagnetic energy and transmit the electromagnetic energy; and
a power receiver assembly disposed at a distance from the power transmitter assembly, the power receiver assembly being electrically connected to the antenna assembly and configured to rotate together with the antenna assembly, and the power receiver assembly being configured to receive the electromagnetic energy, convert the electromagnetic energy into second electric power, and deliver the second electric power to the antenna assembly.

2. The UAV of claim 1, wherein the radar device further includes:
an electric motor arranged at the base and including a rotor connected to the antenna assembly, the electric motor being configured to drive the antenna assembly to rotate around the rotation axis.

3. The UAV of claim 1, wherein:
the power transmitter assembly includes a transmitter coil;
the power receiver assembly includes a receiver coil; and
the transmitter coil is disposed at a distance from the receiver coil.

4. The UAV of claim 3, wherein:
the power transmitter assembly further includes a transmitter control chip, a power supply circuit board, and a transmitter current adjustment circuit;
the power supply circuit board is electrically connected to the transmitter control chip and the transmitter current adjustment circuit, and is configured to supply power to the transmitter current adjustment circuit and the transmitter control chip;
the transmitter control chip is electrically connected to the transmitter current adjustment circuit and is configured to control the transmitter current adjustment circuit to convert a DC power into an AC power having a frequency within a preset frequency range;
the transmitter current adjustment circuit is electrically connected to the transmitter coil and is configured to deliver the AC power to the transmitter coil; and
the transmitter coil is configured to convert the AC power into the electromagnetic energy and transmit the electromagnetic energy.

5. The UAV of claim 4, wherein:
the transmitter current adjustment circuit includes a transmitter current conversion circuit and a resonance circuit;
the transmitter current conversion circuit is configured to convert the DC power from the power supply circuit board into the AC power; and
the resonance circuit is configured to adjust the frequency of the AC power to be within the preset frequency range.

6. The UAV of claim 4, wherein the preset frequency range is 120 KHz˜150 KHz.

7. The UAV of claim 3, wherein:
the power receiver assembly further includes a receiver control chip and a receiver current adjustment circuit;
the receiver coil is electrically connected to the receiver current adjustment circuit and is configured to convert the electromagnetic energy into an AC power and deliver the AC power to the receiver current adjustment circuit;
the receiver control chip is electrically connected to the receiver current adjustment circuit and is configured to control the receiver current adjustment circuit to convert the AC power into a DC power; and
the receiver current adjustment circuit is electrically connected to the antenna assembly and is configured to deliver the DC power to the antenna assembly.

8. The UAV of claim 3, wherein an inductance value range of the transmitter coil is 8.5 uH˜11 uH.

9. The UAV of claim 3, wherein an inductance value range of the receiver coil is 7.5 uH˜11 uH.

10. The UAV of claim 3, wherein a distance range between the transmitter coil and the receiver coil is 1.5 mm˜5 mm.

11. The UAV of claim 2, wherein:
the radar device further includes an antenna bracket supporting the antenna assembly;
the electric motor is configured to drive the antenna bracket to rotate;
the antenna assembly is configured to rotate together with the antenna bracket; and
the power receiver assembly is fixedly mounted at the antenna bracket.

12. The UAV of claim 1, wherein:
the radar device further includes a first wireless communication assembly and a second wireless communication assembly wirelessly communicatively coupled to the first wireless communication assembly;
the first wireless communication assembly is electrically connected to the antenna assembly;
the second wireless communication assembly is mounted at the base; and
the first wireless communication assembly is configured to transmit information detected by the antenna assembly to the second wireless communication assembly and receive request instructions sent by the second wireless communication assembly.

13. The UAV of claim 12, wherein the first wireless communication assembly includes:
an antenna; and
a signal control chip electrically connected to the antenna and configured to control the antenna to transmit and receive data signals.

14. The UAV of claim 13, wherein the antenna includes at least one of a WIFI wireless antenna or a Bluetooth wireless antenna.

15. The UAV of claim 13, wherein the antenna includes a 2.4G wireless antenna or a 5G wireless antenna.

16. The UAV of claim 13, wherein the antenna includes a plate antenna.

17. The UAV of claim 12, wherein the second wireless communication assembly includes:
an antenna; and
a signal control chip electrically connected to the antenna and configured to control the antenna to receive and transmit data signals.

18. The UAV of claim 17, wherein the antenna includes at least one of a WIFI wireless antenna or a Bluetooth wireless antenna, or the first antenna is a 2.4G wireless antenna or a 5G wireless antenna.

19. The UAV of claim 17, wherein the antenna includes a 2.4G wireless antenna or a 5G wireless antenna.

20. The UAV of claim 17, wherein the antenna includes a plate antenna.
